(19) United States
(12) Patent Application Publication
(10) Pub. No.: US 2006/0097962 A1
(43) Pub. Date: May 11, 2006

(54) Plasma display device and driving method thereof

(76) Inventor: Hak-Cheol Yang, Suwon-si (KR)

Correspondence Address: CHRISTIE, PARKER & HALE, LLP, PO BOX 7068, PASADENA, CA, 91109-7068, US

(21) Appl. No.: 11/157,228

(22) Filed: Jun. 20, 2005

(30) Foreign Application Priority Data
Nov. 5, 2004 (KR) 10-2004-0089751

(51) Int. Cl. G09G 3/28

(52) U.S. Cl. 345/63

(57) ABSTRACT

A method for driving a plasma display device having a plurality of discharge cells formed thereon. At least one first discharge cell is selected from among the plurality of discharge cells to be in a light emitting cell state by discharging the at least one first discharge cell in an address period of a first subfield of the at least two subfields in the first group. The at least one first discharge cell in the light emitting cell state is sustain-discharged in a sustain period of the first subfield. At least one second discharge cell of the at least one first discharge cell is selected to be in a non-light emitting cell state by discharging the at least one second discharge cell in an address period of a second subfield that is consecutively provided after the first subfield. The at least one first discharge cell except for the at least one second discharge cell is sustain-discharged in a sustain period of the second subfield.

### CROSS-REFERENCE TO RELATED APPLICATION

This application claims priority to and the benefit of Korean Patent Application No. 10-2004-0089751 filed in the Korean Intellectual Property Office on Nov. 5, 2004, the entire content of which is incorporated herein by reference.

### BACKGROUND OF THE INVENTION

1. Field of the Invention

The present invention relates to a plasma display device and a driving method thereof. More particularly, the present invention relates to a plasma display device driving method for expressing grayscales using subfields.

2. Description of the Related Art

A plasma display device is a flat panel display that uses plasma generated by gas discharge to display characters or images. A plasma display panel (PDP) of a plasma display device includes, depending on its size, more than several hundreds of thousands to millions of pixels arranged in a matrix pattern. A frame of a plasma display device is divided into a plurality of subfields having respective weights and is then driven, and grayscales are represented (or expressed) by a combination of the subfields. On a panel (i.e., PDP) of the plasma display device, a field (e.g., 1 TV field) is divided into a plurality of subfields respectively having a weight. Grayscales are expressed by a combination of weights of subfields from among the subfields, using which a display operation is performed. Each subfield has an address period in which an address operation for selecting discharge cells to emit light and discharge cells to emit no light from among a plurality of discharge cells is performed. Each subfield also includes a sustain period in which a sustain discharge occurs in the selected discharge cells to perform a display operation during a period corresponding to a weight of the subfield.

A method for performing a sustain discharge operation on all the discharge cells after finishing an addressing operation on all the discharge cells in each subfield is generally referred to as an address display period separation method (herein referred to as an ADS method). The ADS method temporally divides the address period and the sustain period. The ADS method is easily realized, but the address operation is sequentially performed on all the discharge cells and hence, the address operation may not be properly performed in the discharge cells that are addressed later in time because of insufficient priming particles in the discharge cells. Therefore, it is needed to increase a width of a scan pulse sequentially applied to row electrodes so as to achieve a stable address discharge. In addition, a length of an address period is increased. Accordingly, a length of a subfield is increased and a number of subfields usable in a field may be limited.

Methods for performing the address operation in the address period include the selective write method and the selective erase method. The selective write method selects discharge cells to emit light and forms a constant wall voltage, which increases an address time since a time for forming the wall voltage is needed. The selective erase method selects discharge cells to emit no light and erases the formed wall voltage, which reduces the address time since no time for forming the wall voltage is required. However, it is difficult in the selective erase method to control the initial wall charge and is impossible to respectively control the same for each subfield. Because of this, the capability to express proper grayscales is degraded.

The above information disclosed in this Background of the Invention section is only for enhancement of understanding of the background of the invention and therefore, it should not be understood that all the above information forms the prior art that is already known in this country to a person of ordinary skill in the art.

### SUMMARY OF THE INVENTION

An aspect of the present invention is to provide a plasma display device and a driving method thereof having a feature of expressing grayscales while reducing an address period.

To achieve this, in one exemplary embodiment, a plurality of subfields are grouped together to be a subfield group for setting light emitting cells by a write discharge and another subfield group for setting light emitting cells by the write discharge and then setting non-light emitting cells by an erase discharge.

In an exemplary embodiment according to the present invention, a method for driving a plasma display device having a plurality of discharge cells formed thereon, is provided. A field is divided into a plurality of subfields having weights for expressing grayscales, the subfields are divided into a plurality of groups having a first group and a second group, and the first group includes at least two subfields which are consecutive in time. At least one first discharge cell is selected from among the plurality of discharge cells to be in a light emitting cell state by discharging the at least one first discharge cell in an address period of a first subfield from among the at least two subfields in the first group. The at least one first discharge cell in the light emitting cell state is sustain-discharged in a sustain period of the first field. At least one second discharge cell is selected of the at least one first discharge cell to be in a non-light emitting cell state by discharging the at least one second discharge cell in an address period of a second subfield that is consecutively provided after the first subfield from among the at least two subfields in the first group. The at least one first discharge cell except for the at least one second discharge cell is sustain-discharged in a sustain period of the second subfield.

In another exemplary embodiment according to the present invention, a plasma display device includes a plasma display panel (PDP), a driver, and a controller. The PDP includes a plurality of row electrodes, a plurality of column electrodes formed to cross the row electrodes, and a plurality of discharge cells defined by the row electrodes and the column electrodes. The driver drives the PDP. The controller controls the driver to divide a field into a plurality of subfields for expressing grayscales, the plurality of subfields including a first subfield and a second subfield. The controller sets at least one of the discharge cells to be in a light emitting cell state in the second subfield that is consecutively provided before the first subfield to set the at least one of the discharge cells to emit light in the first subfield.

In yet another exemplary embodiment according to the present invention, a plasma display device includes a PDP, a driver, and a controller. The PDP includes a plurality of row electrodes, a plurality of column electrodes formed to cross the row electrodes, and a plurality of discharge cells defined by the row electrodes and the column electrodes. The driver drives the PDP. The controller controls the driver to divide a field into a plurality of subfields for expressing grayscales, the subfields including a first subfield and a second subfield. The controller sets a state of a discharge cells from among the plurality of discharge cells to be at least one of: a first light emitting state in which the discharge cell is set to be in a non-light emitting cell state in the first subfield and is set to be in the non-light emitting cell state in a second subfield that is consecutively provided after the first subfield; a second light emitting state in which the discharge cell is set to be in the light emitting cell state in the first subfield and is set to be in the light emitting cell state in the second subfield; and a third light emitting state in which the discharge cell is set to be in the light emitting cell state in the first subfield and is set to be in the non-light emitting cell state in the second subfield.

In yet another exemplary embodiment according to the present invention, a method for driving a plasma display device having a plurality of discharge cells formed thereon, is provided. A field is divided into a plurality of subfields having weights for expressing grayscales, the subfields are divided into a plurality of groups having a first group and a second group, and the first group includes at least two subfields which are consecutive in time. A wall charge is formed on at least one first discharge cell from among the plurality of discharge cells in an address period of a first subfield from among the at least two subfields in the first group, and the at least one first discharge cell is sustain-discharged in a sustain period of the first subfield. The wall charge is erased on at least one second discharge cell of the at least one first discharge cell in an address period of a second subfield that is consecutively provided after the first subfield from among the at least two subfields in the first group, and the at least one first discharge cell except for the at least one second discharge cell is sustain-discharged in a sustain period of the second subfield.

### BRIEF DESCRIPTION OF THE DRAWINGS

FIG. 1 is a schematic diagram of a plasma display device according to an exemplary embodiment of the present invention.

FIG. 2 shows a table that illustrates a plasma display device driving method according to a first exemplary embodiment of the present invention.

FIG. 3 shows a detailed diagram for a plasma display device driving method according to the first exemplary embodiment of the present invention.

FIG. 4 shows a table that illustrates an expression of grayscales in the driving method according to the first exemplary embodiment of the present invention.

FIG. 5 is a plasma display device driving waveform diagram according to the first exemplary embodiment of the present invention.

FIG. 6 shows a table that illustrates a plasma display device driving method according to a second exemplary embodiment of the present invention.

FIG. 7A and FIG. 7B show tables that illustrate an expression of grayscales in the driving method according to the second exemplary embodiment of the present invention.

FIG. 8A to FIG. 8C show tables that illustrate total times for a general driving method, and driving methods according to the first and second exemplary embodiments of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

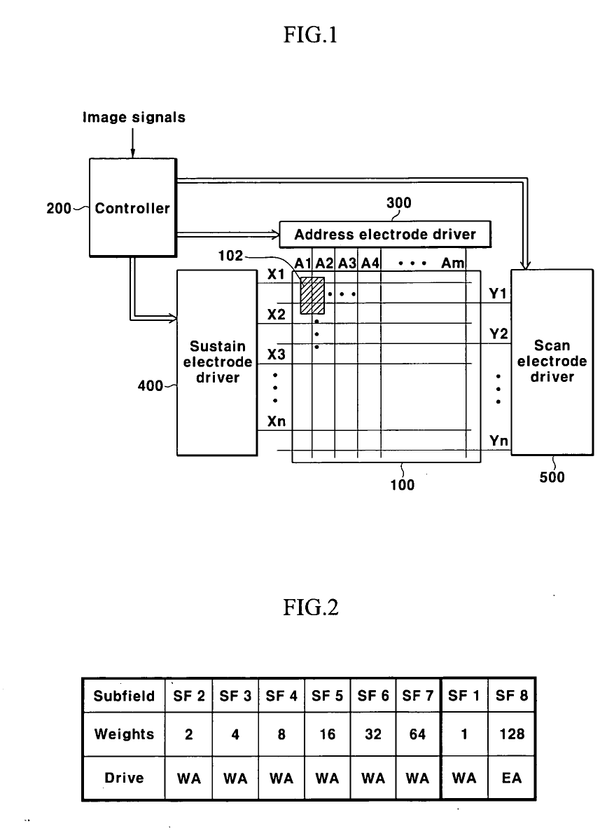

A plasma display device and a driving method thereof according to an exemplary embodiment of the present invention will be described with reference to the drawings. A plasma display device configuration according to an exemplary embodiment of the present invention will be described with reference to FIG. 1.

FIG. 1 is a schematic diagram for a plasma display device according to an exemplary embodiment of the present invention.

As shown in FIG. 1, the plasma display device includes a plasma display panel (PDP) 100, a controller 200, an address electrode driver 300, a sustain electrode driver 400, and a scan electrode driver 500.

The PDP 100 includes a plurality of address electrodes (“A electrodes”) A1-Am arranged in a column direction, and a plurality of sustain electrodes (“X electrodes”) X1-Xn and a plurality of Y electrodes (“Y electrodes”) Y1-Yn arranged in pairs in a row direction. The X electrodes X1-Xn are formed to correspond to the Y electrodes Y1-Yn. The Y electrodes Y1-Yn, and the A electrodes A1-Am, and the X electrodes X1-Xn and the A electrodes A1-Am are respectively arranged to cross with each other. In the PDP 100, discharge spaces provided at crossing regions of the address electrodes and the X and Y electrodes form discharge cells 102. The configuration of the PDP 100 shows one exemplary embodiment. In other embodiments, the driving waveforms described below may be applied to other types of panels. In the plasma display device of FIG. 1, a pair of X and Y electrodes in the row direction are defined to be row electrodes, and an A electrode in the column direction is defined to be a column electrode.

The controller 200 receives an external video signal (i.e., image signals) and outputs an A electrode driving control signal, an X electrode driving control signal, and a Y electrode driving control signal, and divides a field into a plurality of subfields having different weights. The address electrode driver 300 receives the A electrode driving control signal from the controller 200, and applies a display data signal for selecting a discharge cell to be displayed to the A electrodes. The sustain electrode driver 400 receives the X electrode driving control signal from the controller 200 and applies a driving voltage to the X electrodes. The scan electrode driver 500 receives the Y electrode driving control signal from the controller 200 and applies a driving voltage to the Y electrodes.

A plasma display device driving method according to a first exemplary embodiment of the present invention will be described with a reference to FIG. 2 to FIG. 5.

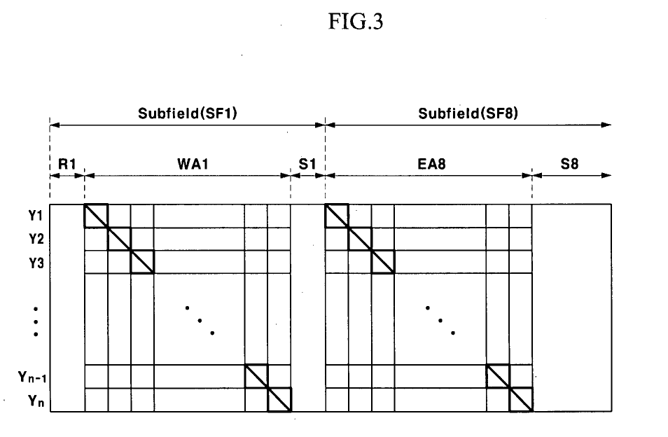

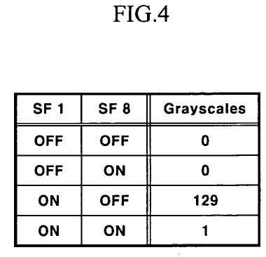

FIG. 2 shows a table that illustrates a plasma display device driving method according to the first exemplary embodiment of the present invention. FIG. 3 shows a detailed diagram for a plasma display device driving method according to the first exemplary embodiment of the present invention. FIG. 4 shows a table that illustrates an expression of grayscales in the driving method according to the first exemplary embodiment of the present invention. A field is described as having eight subfields (SF1-SF8), and FIG. 3 and FIG. 4 show only the first and eighth subfields SF1 and SF8.

As shown in FIG. 2, a field has a plurality of subfields (SF1-SF8), and the subfields respectively have weights of 1, 2, 4, 8, 16, 32, 64, and 128. Each of the first to seventh subfields (SF1-SF7) has a reset period, an address period, and a sustain period, and each of the address periods of the first to seventh subfields (SF1-SF7) is based on the selective write method (referred to herein as “WA”). In this case, the reset period is a period for resetting the discharge cells into discharge cells that are not to emit light. The eighth subfield SF8 with the highest weight has an address period and a sustain period. The address period of the eighth subfield SF8 is based on the selective erase method (referred to herein as “EA”).

As described above, the methods for selecting discharge cells to emit light and discharge cells to emit no light in the address period include the selective write method (“WA”) and the selective erase method (“EA”). The selective write method selects discharge cells to emit light and forms a constant wall voltage. The selective erase method selects discharge cells to emit no light and erases the formed wall voltage. According to these methods, a state of a discharge cell selected as a discharge cell to emit light will be referred to herein as a “light emitting cell state” and a state of a discharge cell selected as a discharge cell to emit no light will be referred to as a “non-light emitting cell state.” The selective write method is denoted as Write Address (WA) and the selective erase method is denoted as Erase Address (EA) in FIG. 2.

In the eighth subfield SF8, it is allowed to set the cell in the light emitting cell state in the previous subfield to be in a non-light emitting cell state, but it is not allowed to set the cell in the non-light emitting cell state in the previous subfield to be in a light emitting cell state. That is, it is not allowed to control the cell to emit light in the eighth subfield SF8 when the cell did not emit light in the previous subfield. Therefore, the subfield SF1 having the lowest weight and the subfield SF8 having the highest weight are combined to be near each other in a field, the selective write method (WA) is applied to the subfield SF1 having the lowest weight, and the selective erase method (EA) is applied to the subfield SF8 having the highest weight.

In detail, referring to FIG. 3, the discharge cells are reset to be in the non-light emitting cell state in the reset period (R1) of the first subfield SF1. A selective write discharge is performed on the discharge cells to be turned on to select cells to emit light from among the discharge cells in the address period (WA1) of the first subfield SF1, and discharge cells in the light emitting cell state are sustain-discharged in the sustain period (S1). A selective erase discharge is performed on the discharge cells to be turned off to select cells to emit no light from among the discharge cells in the address period (EA8) of the eighth subfield SF8, and the discharge cells in the light emitting cell state are sustain-discharged in the sustain period (S8). In other words, the discharge cells which are not erase-discharged from among the discharge cells selected as discharge cells to emit light in the subfield SF1, are sustain-discharged in the sustain period (S8). Operations in the reset period, the address period, and the sustain period are performed in the other subfields (SF2-SF7) in a like manner as the first subfield SF1.

A method for expressing grayscale by the driving method of FIG. 2 will be described with reference to FIG. 4. The state of “ON” represents a light emitting cell state in the selective write type subfield SF1 and a non-light emitting cell state in the selective erase type subfield SF8.

When the state of a discharge cell becomes the non-light emitting cell state (OFF) in the address period of the first subfield SF1, no sustain discharge is generated in the sustain period, no sustain discharge is generated in the eighth subfield SF8 next to the first subfield SF1, and the grayscale of 0 is expressed. When a write discharge is generated on the discharge cell to control the discharge cell to be in the light emitting cell state (ON) in the address period of the first subfield SF1, a sustain discharge is generated and the grayscale of 1 is expressed in the sustain period. When an erase discharge is generated to control the discharge cell to be in the non-light emitting cell state (ON) in the eighth subfield SF8, no sustain discharge is generated and the final grayscale is given to be 1 in the eighth subfield SF8. When no erase discharge is generated, the state is maintained at the light emitting cell state (ON), a sustain discharge is generated in the eighth subfield SF8, and the grayscale of 129 is expressed as a combination of the grayscales expressed during the sustain periods of the first subfield SF1 and the eighth subfield SF8.

A write discharge is generated in the second to seventh subfields (SF2-SF7), and the grayscales are expressed by a combination of weights of subfields that are in the light emitting cell state. Accordingly, the grayscales of a frame are expressed by a summation of grayscales of the first and eighth subfields SF1 and SF8 and grayscales of the second to seventh subfields (SF2-SF7).

For example, the grayscale of 5 (=1+4) is expressed when a write discharge is generated to control the discharge cell to be in the light emitting cell state in the first and third subfields SF1 and SF3, and an erase discharge is generated to control the discharge cell to be in the non-light emitting cell state in the eighth subfield SF8. The grayscale of 133 (=1+4+128) is expressed when no erase discharge occurs in the eighth subfield SF8 to control the discharge cell to be in the light emitting cell state.

As described above, since the selective erase method selects discharge cells to emit no light and erases wall charges while the wall charges are being formed, the eighth subfield SF8 driven by the selective erase method cannot be driven and the grayscale of 128 is not expressed. However, the grayscale of 128 can be adequately represented by the grayscale of 129 since the user cannot sense a small difference of the grayscales at relatively high brightness.

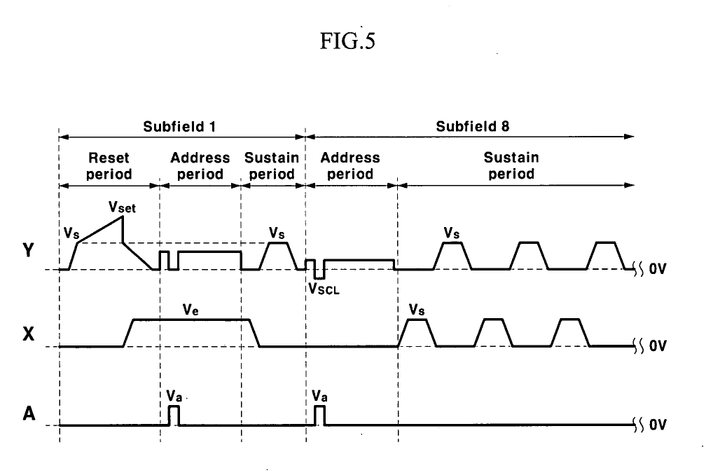

A driving waveform for the PDP driving method according to the first exemplary embodiment of the present invention will be described with reference to FIG. 5.

FIG. 5 shows a plasma display device driving waveform diagram according to the first exemplary embodiment of the present invention. For ease of description, the driving waveform applied to the Y electrode, the X electrode, and the A electrode forming a discharge cell will be described. The driving waveform in FIG. 5 represents a general plasma display device driving waveform, and the same will not be described.

As shown in FIG. 5, a voltage at the Y electrode is gradually increased from the voltage of Vs to the voltage of Vset to generate a reset discharge, and wall charges are formed on the discharge cell by the reset discharge, while the X electrode is biased with the ground voltage of 0V in the reset period of the first subfield. Next, the voltage at the Y electrode is gradually decreased from the voltage of Vs to the ground voltage of 0V while the X electrode is biased with the positive voltage of Ve. The wall charges are then erased from the discharge cell and the discharge cell is reset.

In the address period, a scan pulse (the ground voltage in FIG. 5) is sequentially applied to the Y electrode, and a positive address voltage of Va is applied to the A electrode of the discharge cell to emit light, while the X electrode is biased with the positive voltage of Ve. At this time, the discharge cell to which the address voltage of Va is applied is formed by the Y electrode to which the scan pulse is applied. A write discharge is then generated at the discharge cell to which the voltage of the pulse and the address voltage are applied, and a wall voltage is formed at the X and Y electrodes.

In the sustain period, the voltage of Vs of the sustain discharge pulse is applied to the Y electrode and a discharge is generated at the discharge cell in the light emitting cell state. As illustrated in FIG. 4, one sustain discharge pulse is applied in the first subfield SF1.

Next, in the address period of the eighth subfield, a scan pulse with the negative voltage of VscL is sequentially applied to the Y electrode and a positive address voltage of Va is applied to the A electrode of the discharge cell to set the discharge cell to be in the non-light emitting cell state, while the X electrode is biased with the ground voltage of 0V. In this case, the width of the scan pulse is controlled to be narrow so that the wall charges are not formed but are erased by the discharge. An erase discharge is then generated at the discharge cell to which the voltage of the scan pulse (applied to the Y electrode) and the address voltage (applied to the A electrode) are applied to erase the wall voltages formed at the X electrode and the Y electrode, and the state of the discharge cell then becomes the non-light emitting cell state.

In the sustain period of the eighth subfield SF8, the voltage of Vs of the sustain discharge pulse is applied to the X electrode to generate a discharge at the discharge cell, and the voltage of Vs of the sustain discharge pulse is applied to the Y electrode to generate a discharge at the discharge cell in the light emitting cell state. In this case, since the weight ratio of the first and eighth subfields is assumed to be 1:128, 128 sustain discharge pulses are applied in the sustain period of the eighth subfield. Accordingly, the address period is reduced since the width of the scan pulse is controlled to be narrower so the wall charges may be erased in the address period of the selective erase type in the first exemplary embodiment of the present invention.

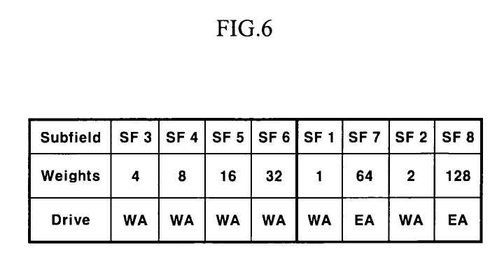

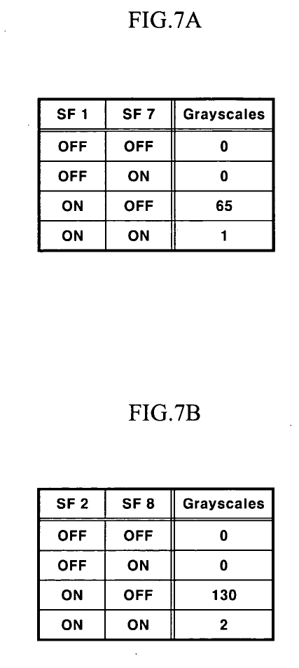

The selective erase method has been used for the one subfield SF8 in the first exemplary embodiment of the present invention. However, the selective erase method can also be used for at least one or more other subfields, which will be described in detail with reference to FIG. 6 to FIG. 7B.

FIG. 6 shows a table that illustrates a plasma display device driving method according to a second exemplary embodiment of the present invention. FIG. 7A and FIG. 7B show tables that illustrate an expression of grayscales in the driving method according to the second exemplary embodiment of the present invention.

As shown in FIG. 6, the subfields (SF1-SF8) are divided into two groups. The subfields of the first group have a plurality of sub-groups, and each sub-group has two subfields that are consecutive in time. The first sub-group has a subfield SF1 having the minimum weight and a subfield SF7 having a weight lower than the maximum weight by one step (here, the number of sustain pulses is one-half that of the maximum weight), and the second sub-group has a subfield SF2 having a weight higher than the minimum weight by one step and a subfield SF8 having the maximum weight. The second group has the other subfields (SF3-SF6).

In this case, the selective erase method (EA) is used in the address periods of the seventh and eighth subfields SF7 and SF8 of the first and second sub-groups, and the selective write method (WA) is used in the address periods of the other subfields (SF1-SF6). Therefore, grayscales are expressed by the combination of the weights in the subfields (SF3-SF6) of the second group, and the grayscales of 1 is expressed in the subfields SF1 of the first sub-group. The grayscale of 65 is expressed using a combination of the grayscales of the subfields SF1 and SF7 as shown in FIG. 7A. Also, the grayscales of 2 is expressed in the subfields SF2 of the second sub-group. The grayscale of 130 is expressed using a combination of the grayscales of the subfields SF2 and SF8 as shown in FIG. 7B. In this case, the subfields SF1, SF2, SF7, and SF8 in the first and second sub-groups express the grayscales in a like manner as the subfields SF1 and SF8 described in reference to the first exemplary embodiment.

Differing from FIG. 6, the grayscales of 1 and 129 may be expressed in the first sub-group and the grayscales of 2 and 66 are expressed in the second sub-group when the first sub-group has the first and eighth subfields SF1 and SF8 and the second sub-group has the second and seventh subfields SF2 and SF7. In this case, the grayscale of 128 is replaced by the grayscale of 129, and the grayscale of 64 is replaced by the grayscale of 66. However, the grayscale of 128 is replaced by the grayscale of 130, and the grayscale of 64 is replaced by the grayscale of 65 according to the second exemplary embodiment of the present invention. As described above, the user senses differences of low grayscales better than those of high grayscales because of characteristics of human eyes. Therefore, the subfields are arranged according to the second exemplary embodiment of the present invention since the grayscales are expressed more efficiently when the difference between the low grayscale and the actual grayscale to be expressed is controlled to be reduced.

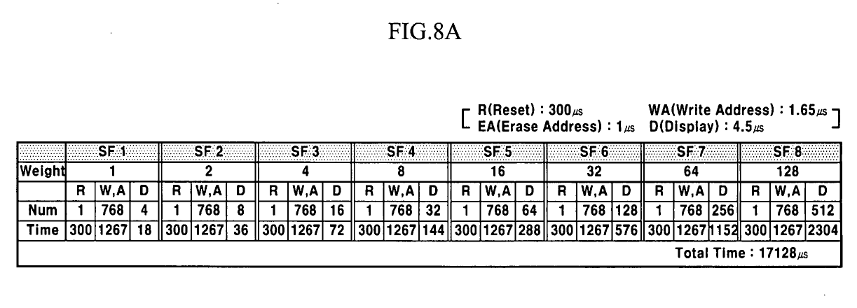

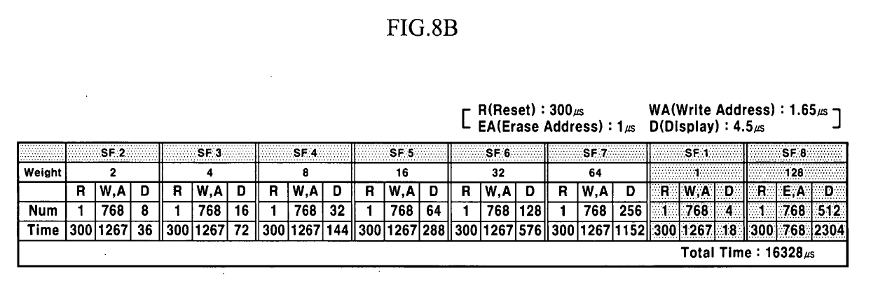

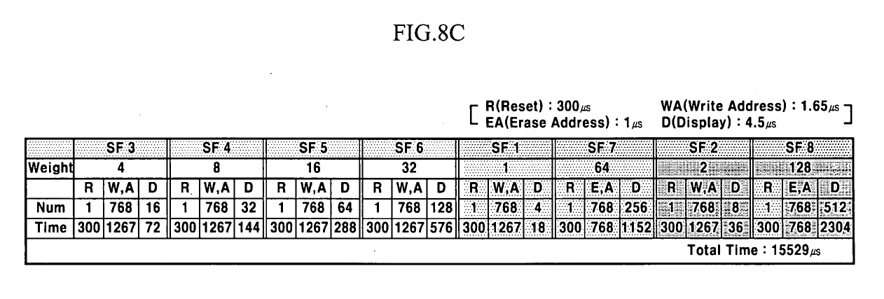

Efficiencies of using the driving method according to the first and second exemplary embodiments of the present invention will now be described with reference to FIG. 8A to FIG. 8C.

FIG. 8A shows a table that illustrates a total time when the selective write method is applied in a field, FIG. 8B shows a table that illustrates a total time when the driving method according to the first exemplary embodiment is used, and FIG. 8C shows a table that illustrates a total time when the driving method according to the second exemplary embodiment is used. In these tables, the total time represents a summation of the reset period, the address period, and the sustain period in all subfields (SF1-SF8). It is assumed in FIG. 8A to FIG. 8C that high-definition (HD) level single driving with 768 row lines is used and the number of sustain discharge pulses of the first subfield SF1 is given to be four. It is also assumed that weights of the first to eighth subfields (SF1-SF8) are given to be 1, 2, 4, 8, 16, 32, 64, and 128. Further, the reset time (R) is given as 300 μs, the scan pulse apply time (WA) according to the selective write method (WA) is given as 1.65 μs, the scan pulse apply time (EA) according to the selective erase method (EA) is given as 1 μs, and the sustain discharge pulse apply time (D) is given as 4.5 μs.

It can be seen from FIG. 8A to FIG. 8C that the total time is reduced when the subfields using the selective erase method (EA) are increased in one field. However, when the subfields using the selective erase method (EA) are increased in one field, the total time may be reduced but the expression of grayscales is degraded, and hence, the number of subfields using the selective erase method (EA) in one field should be appropriately controlled according to the second exemplary embodiment of the present invention.

In detail, referring to FIG. 8A, the total time of 17.128 ms is shown for one field having eight subfields. Since a period of a field in a National Television System Committee (NTSC) system is given as 16.67 ms ( 1/60 Hz), it is not possible to use the eight subfields (SF1-SF8) in one field using the general driving method of FIG. 8A. Therefore, it is needed to control the number of subfields when the subfields (SF1-SF8) in one field use the selective write method. However, referring to FIG. 8B and FIG. 8C, the eight subfields (SF1-SF8) are usable in one field since the total times are respectively given as 16.328 ms and 15.529 ms.

According to the exemplary embodiments of the present invention, the address period is reduced and the total time is accordingly reduced by consecutively arranging the subfields with the temporal minimum weight and the subfield with the maximum weight, using the selective write method in the address period of the subfield with the minimum weight and using the selective erase method in the address period of the subfield with the maximum weight.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for driving a plasma display device having a plurality of discharge cells formed thereon, wherein a field is divided into a plurality of subfields having weights for expressing grayscales, the subfields are divided into a plurality of groups having a first group and a second group, and the first group includes at least two subfields which are consecutive in time, the method comprising:
selecting at least one first discharge cell from among the plurality of discharge cells to be in a light emitting cell state by discharging the at least one first discharge cell in an address period of a first subfield from among the at least two subfields in the first group;
sustain-discharging the at least one first discharge cell in the light emitting cell state in a sustain period of the first subfield;
selecting at least one second discharge cell of the at least one first discharge cell to be in a non-light emitting cell state by discharging the at least one second discharge cell in an address period of a second subfield that is consecutively provided after the first subfield from among the at least two subfields in the first group; and
sustain-discharging the at least one first discharge cell except for the at least one second discharge cell in a sustain period of the second subfield.

2. The method of claim 1, wherein a weight of the first subfield is less than a weight of the second subfield.

3. The method of claim 2, wherein the first subfield has a minimum weight among the plurality of subfields, and the second subfield has a maximum weight among the plurality of subfields.

4. The method of claim 1, wherein the first group includes a plurality of sub-groups each having two subfields that are consecutive in time from among the plurality of subfields,
in a first sub-group from among the plurality of sub-groups, one of the two subfields provided before the other one of the two subfields has a minimum weight among the plurality of subfields, and
in a second sub-group from among the plurality of sub-groups, one of the two subfields provided after the other one of the two subfields has a maximum weight among the plurality of subfields.

5. The method of claim 4, wherein the first group includes N sub-groups, where N is an integer greater than 2,
in the first sub-group, one of the two subfields provided after the other one of the two subfields is an N^{th} subfield when the subfields are arranged in an order of weights from lowest to highest, and
in the second sub-group, one of the two subfields provided before the other one of the two subfields is an N^{th} subfield when the subfields are arranged in an order of weights from highest to lowest.

6. The method of claim 1, wherein the second group includes at least two subfields which are consecutive in time, further comprising:
selecting a third discharge cell from among the plurality of discharge cells to emit light by discharging the third discharge cell in an address period of one of the at least two subfields in the second group; and
sustain-discharging the third discharge cell to emit light in a sustain period of the one of the at least two subfields in the second group.

7. The method of claim 6, further comprising selecting a fourth discharge cell from among the plurality of discharge cells to emit light by discharging the fourth discharge cell in an address period of the other one of the at least two subfields in the second group.

8. The method of claim 6, further comprising sustain-discharging a fourth the discharge cell in a sustain period of the other one of the at least two subfields in the second group, wherein the fourth discharge cell is discharged in an address period of the other one of the at least two subfields in the second group.

9. The method of claim 1, wherein selecting the at least one first discharge cell from among the plurality of discharge cells to be in the light emitting cell state comprises forming a wall charge on the at least one first discharge cell, and wherein selecting the at least one second discharge cell of at least one first discharge cell to be in the non-light emitting cell state comprises erasing a wall charge on the at least second discharge cell.

10. A plasma display device comprising:
a plasma display panel (PDP) including a plurality of row electrodes, a plurality of column electrodes formed to cross the row electrodes, and a plurality of discharge cells defined by the row electrodes and the column electrodes;
a driver for driving the PDP; and
a controller for controlling the driver to divide a field into a plurality of subfields for expressing grayscales, the plurality of subfields comprising a first subfield and a second subfield,
wherein the controller sets at least one of the discharge cells to be in a light emitting cell state in the second subfield that is consecutively provided before the first subfield to set the at least one of the discharge cells to emit light in the first subfield.

11. The plasma display device of claim 10, wherein the at least one of the discharge cells in the light emitting cell state is set to be in a non-light emitting cell state because of an address discharge in the first subfield, and
the at least one of the discharge cells in the non-light emitting cell state is set to be in the light emitting cell state because of an address discharge in the second subfield.

12. The plasma display device of claim 10, wherein a weight of the first subfield is greater than a weight of the second subfield.

13. The plasma display device of claim 12, wherein the first subfield has a maximum weight among the subfields, and the second subfield has a minimum weight among the subfields.

14. The plasma display device of claim 10, wherein the subfields are divided into a plurality of groups comprising a first group and a second group, and the first group includes a plurality of sub-groups including two subfields which are consecutive in time, the second subfield of the first sub-group has a minimum weight among the subfields, and the first subfield of the second sub-group has a maximum weight among the subfields.

15. The plasma display device of claim 14, wherein the first group includes N sub-groups, where N is an integer greater than 2, the first subfield in the first sub-group is an N^{th} subfield when the subfields are arranged in an order of weights from lowest to highest, and the second subfield in the second sub-group is an N^{th} subfield when the subfields are arranged in an order of weights from highest to lowest.

16. A plasma display device comprising:
a plasma display panel (PDP) including a plurality of row electrodes, a plurality of column electrodes formed to cross the row electrodes, and a plurality of discharge cells defined by the row electrodes and the column electrodes;
a driver for driving the PDP; and
a controller for controlling the driver to divide a field into a plurality of subfields for expressing grayscales, the subfields comprising a first subfield and a second subfield,
wherein the controller sets a state of a discharge cell from among the plurality of discharge cells to be at least one of: a first light emitting state in which the discharge cell is set to be in a non-light emitting cell state in the first subfield and is set to be in the non-light emitting cell state in a second subfield that is consecutively provided after the first subfield; a second light emitting state in which the discharge cell is set to be in the light emitting cell state in the first subfield and is set to be in the light emitting cell state in the second subfield; and a third light emitting state in which the discharge cell is set to be in the light emitting cell state in the first subfield and is set to be in the non-light emitting cell state in the second subfield.

17. The plasma display device of claim 16, wherein a weight of the first subfield is less than a weight of the second subfield.

18. The plasma display device of claim 17,
wherein the first subfield has a minimum weight or a weight that is just above the minimum weight among the plurality of subfields, and
wherein the second subfield has a maximum weight or a weight that is just below the maximum weight among the plurality of subfields.

19. A method for driving a plasma display device having a plurality of discharge cells formed thereon, wherein a field is divided into a plurality of subfields having weights for expressing grayscales, the subfields are divided into a plurality of groups having a first group and a second group, and the first group includes at least two subfields which are consecutive in time, the method comprising:
forming a wall charge on at least one first discharge cell from among the plurality of discharge cells in an address period of a first subfield from among the at least two subfields in the first group;
sustain-discharging the at least one first discharge cell in a sustain period of the first subfield;
erasing the wall charge on at least one second discharge cell of the at least one first discharge cell in an address period of a second subfield that is consecutively provided after the first subfield from among the at least two subfields in the first group; and
sustain-discharging the at least one first discharge cell, except for the at least one second discharge cell in a sustain period of the second subfield.

20. The method of claim 19, wherein a weight of the first subfield is less than a weight of the second subfield.
